(19) United States
(12) Patent Application Publication
(10) Pub. No.: US 2024/0076233 A1
(43) Pub. Date: Mar. 7, 2024

(54) USE OF BRINE IN A METHOD OF MAKING CEMENTITIOUS COMPOSITIONS AND USES THEREOF

(71) Applicant: PARTANNA GLOBAL, INC., Rancho Santa Fe, CA (US)

(72) Inventors: Sam Franklin MARSHALL, Hidden Hills, CA (US); Rebekkah Swisher, Rancho Santa Fe, CA (US)

(21) Appl. No.: 18/462,200

(22) Filed: Sep. 6, 2023

Related U.S. Application Data
(60) Provisional application No. 63/374,859, filed on Sep. 7, 2022.

(51) Int. Cl. C04B 7/14; C04B 22/06; C04B 28/08

(52) U.S. Cl. CPC C04B 7/14; C04B 22/066; C04B 28/08; C04B 2111/00017

(57) ABSTRACT

Provided herein, inter alia, are compositions of cementitious products using recycled materials including desalinated waste products and seawater, the methods of preparing, and uses thereof.

The present application claims the benefit of priority to under 35 U.S.C. § 119(e) to U.S. Provisional Application No. 63/374,859, filed Sep. 7, 2022, the entirety of which is incorporated by reference herein.

### BACKGROUND

In 2015, worldwide Portland Cement manufacture contributed approximately 2.8 billion metric tons of carbon dioxide, CO₂, emissions. These emissions equate to about 8% of the global total of CO₂ emissions. The production of Portland clinker, which acts as the binder, is a critical step in making ordinary Portland Cement (OPC). Limestone (CaCO₃) is calcinated at high temperatures in a cement kiln to produce lime (CaO), leading to the release of waste CO₂.

This decarbonation reaction accounts for approximately 50% of the produced CO₂ emissions, with 40% of emissions coming from burning fossil fuels to heat kilns to the high temperatures needed for this calcination process, and 10% of emissions from fuels required to mine and transport the raw materials. Every ton of Portland Cement produced contributes about a ton of CO₂ both directly through the heat of decomposition of calcium carbonate to produce lime and CO₂, and indirectly through burning fossil fuel to heat the calcium carbonate in the kilns.

The cement industry has attempted to reduce emissions over the last several decades. The industry has implemented energy-efficient kilns, lower-emission fuels, and increased clinker substitution. However, these levers cannot meet the necessary 24% cut in cement emissions needed to limit global temperature rise to below 2° C. (3.8° F.) as defined in the Paris Agreement. Technologies such as carbon capture and storage (CSS) and “novel” cements have been explored to achieve this goal. CSS has not reached commercial-scale development due to cost and energy consumption, and it will be challenging to achieve. Hence, alternative cement technology provides the most logical pathway to reduce emissions in the industry. The present embodiments meet this and other needs.

### BRIEF SUMMARY

The present application generally relates to an alternative “cement” (e.g., a material that sets, hardens, and/or adheres to other materials to bind them to together, for example to make materials such as concrete) technology comprising Mg(OH)₂ that has improved physical properties including offsetting greenhouse gases and uses brine sourced from either seawater or desalinated water waste product to reduce the energy requirements, cost requirements, and environmental impact.

In an aspect, provided herein is an artificial, stonelike material set by pouring a concrete mixture, the poured concrete mixture comprising: (a) a brine slurry comprising water and Mg(OH)₂; and, (b) slag.

In an aspect, provided herein is an artificial, stonelike material set by pouring a concrete mixture, the poured concrete mixture comprising: (a) a brine slurry comprising water, Mg(OH)₂, nitrate, sulfate, sodium, chloride, and potassium; (b) slag; and, (c) at least one aggregate.

In an aspect, provided herein is an artificial, stonelike material formed from a poured concrete mixture and configured to absorb and retain carbon dioxide, the poured concrete mixture comprising (a) a brine slurry comprising water, Mg(OH)₂, and one or more nitrate, sulfate, sodium, chloride, and potassium; (b) slag; and, (c) optionally at least one aggregate.

In an aspect, provided herein is a manufacturing process of a negative-carbon dioxide emitting artificial, stonelike material comprising (a) mixing a brine slurry comprising water, Mg(OH)₂, and one or more nitrate, sulfate, sodium, chloride, and potassium, with slag to form a concrete mixture; (b) pouring the concrete mixture into a structural component mold to form a poured concrete mixture; and then (c) curing the poured concrete mixture from step (b) in the structural mold to form a negative-carbon dioxide emitting artificial, stonelike material.

In an aspect, provided herein is an artificial, stonelike material comprising (a) a brine slurry comprising water and Mg(OH)₂; and (b) slag; wherein the concrete mixture has a pH of at least 12.

In an aspect, provided herein is material comprising a (a) salt water material comprising water, Mg(OH)₂, and one or more of nitrate, sulfate, sodium, chloride, and potassium; and (b) cementious material.

### BRIEF DESCRIPTION OF THE DRAWINGS

FIG. 1 illustrates Portland Cement production that currently accounts for approximately 8% of the world's carbon dioxide emissions. Approximately 50% of these emissions are released as a chemical byproduct of the decarbonation of limestone (CaCO₃), 40% from burning fossil fuels, and 10% to mine and transport the raw materials.

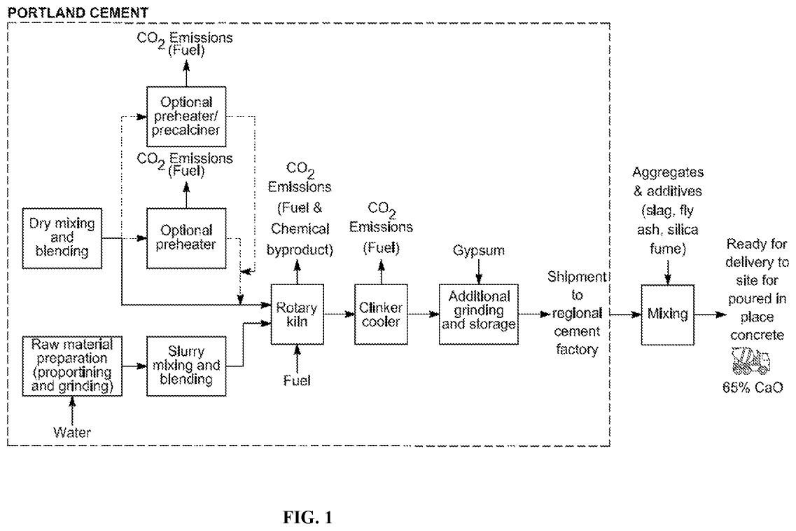

FIG. 2 illustrates the carbon dioxide emission comparison of different starting materials including Portland Cement, mined MgO, and Mg(OH)₂ from brine.

### DETAILED DESCRIPTION

The present embodiments provide an artificial, stonelike material set by pouring a concrete mixture, the poured concrete mixture comprising: (a) a brine slurry comprising water, Mg(OH)₂, nitrate, sulfate, sodium, chloride, and potassium; (b) slag; and, (c) at least one aggregate.

Conventionally, concrete is a mixture of paste and aggregates, or rocks. The paste, composed of a cementitious material and water, coats the surface of the fine and coarse aggregates. Through a chemical reaction called hydration, the paste hardens and gains strength to form the rock-like mass known as concrete. Concrete can be suitable for building skyscrapers, bridges, sidewalks and superhighways, houses and dams.

The cementitious material of conventional forms of concrete include Portland Cement. Portland Cement is a fine powder, produced by heating limestone (CaO) and clay minerals in a kiln to form clinker, grinding the clinker, and adding 2% to 3% of gypsum. Several types of Portland Cement are available including ordinary Portland Cement (OPC), which is grey, and white Portland Cement. The low cost and widespread availability of the limestone, shales, and other naturally-occurring materials used in Portland Cement make it one of the lowest-cost materials widely used over the last century. However, it is one of the construction industry's largest cause of climate changing carbon dioxide emissions.

The manufacture of Portland Cement can cause environmental impacts at all stages of the process. These include emissions of airborne pollution in the form of dust, gases; release of carbon dioxide from the raw materials during manufacture, and damage to countryside from quarrying.

One of the most promising categories of alternative cement technologies is magnesium-oxide cement (MOC), partly because it has already been proven as a commercially viable material. MOCs have been produced for over 150 years and can be used as alternative binders to the high CO₂ emitting Portland Cement. MOC, by definition, uses MgO rather than CaO, which comprises more than 60% of the elemental composition of Portland Cement. Some of the advantages of MgO include: (1) does not require wet curing, (2) has high fire resistance, (3) has low thermal conductivity, (4) has good resistance to abrasion and, (5) can reach high compressive strengths of up to 85 MPa.

In addition to their potential performance advantages, magnesium oxide-based cements have often been described as eco- or low-carbon emission cements in the literature for a number of reasons. First, the temperatures required for the production of MgO cement are lower than those required for the conversion of CaCO₃ to Portland Cement. Therefore, less fuel is required, and therefore less CO₂ emissions are generated from its combustion.

Although the production of MOC itself does not generate CO₂, the route to MgO sometimes does. Thus, when the lifecycle of MOC is considered, the net carbon emissions depend on the source of the MgO and the burden of carbon emissions it arrives with. Presently, the most common source of MgO for cement product manufacturing is through dry route calcining magnesite (MgCO₃) or brucite, which are found in naturally occurring deposits. When MgO is produced from magnesite, the latter undergoes a calcination reaction similar to the calcination of limestone used in Portland Cement, releasing CO₂ as a byproduct. That release of CO₂ offsets the net carbon benefit obtained later in curing.

MgCO₃→MgO+CO₂

While magnesite utilizes a lower processing temperature (700-1,000° C.) in comparison to ordinary Portland Cement (1450° C.), the full decomposition of magnesite yields approximately identical amounts of CO₂ on a molar basis to OPC. On a mass basis, magnesite calcination shows increased process-based CO₂ emissions over calcite calcination due to the higher atomic mass of calcium in comparison to magnesium.

The present application is directed to the unexpected benefits of using Mg(OH)₂ as an alternative to other cement technologies, including MgO. For example, Mg(OH)₂ avoids problems associated with the depletion of high-grade ores in land-based mining and is instead sourced from either existing natural sources, such as “recycled” water from waste brine, which is readily available in growing quantities. Natural resources such as seawater and recycled waste brine also contains sodium, chloride, nitrates, sulfates, and potassium in concentrations at or near to the amounts needed to produce the contemplated cement products. Thus, using Mg(OH)₂ from natural resources avoids the problem of sourcing large quantities of chemical compounds needed for producing cement products thereby further offsetting the carbon-dioxide and energy requirements.

### I. Definitions

Before the present invention is further described, it is to be understood that this invention is not strictly limited to particular embodiments described, as such may of course vary. It is also to be understood that the terminology used herein is for the purpose of describing particular embodiments only, and is not intended to be limiting, since the scope of the present invention will be limited only by the claims.

It must be noted that as used herein and in the appended claims, the singular forms “a,” “an,” and “the” include plural referents unless the context clearly dictates otherwise. It should further be understood that as used herein, the term “a” entity or “an” entity refers to one or more of that entity. For example, a nucleic acid molecule refers to one or more nucleic acid molecules. As such, the terms “a”, “an”, “one or more” and “at least one” can be used interchangeably. Similarly the terms “comprising”, “including” and “having” can be used interchangeably.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed. In addition, all sub-combinations are also specifically embraced by the present invention and are disclosed herein just as if each and every such sub-combination was individually and explicitly disclosed herein.

It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As used herein, the term “about” means a range of values including the specified value, which a person of ordinary skill in the art would consider reasonably similar to the specified value. In embodiments, about means within a standard deviation using measurements generally acceptable in the art. In embodiments, about means a range extending to +/−10% of the specified value. In embodiments, about means the specified value.

As used herein, the term “accelerant” is used in accordance with its plain ordinary meaning and refers a substance that improves the chemical reaction and affords a higher strength material. In embodiments, accelerants contemplated in the present application are potassium and chloride.

As used herein, the term “aggregates” or “aggregate” is used in accordance with its plain ordinary meaning and refers to inert granular materials such as sand, gravel, or crushed stone whether normal weight and/or lightweight that, along with cementitious materials and other optional raw materials such as pigment and/or admixtures, are used in concrete. Further, the term “aggregates” as used herein can include ASTM International C 33 fine aggregates, ASTM International C 33 coarse aggregates, and other particulate materials mixed into a concrete mixture. The aggregate can be processed: crushed, screened, and washed to obtain proper cleanliness and gradation. In some cases, a beneficiation process such as jigging or heavy media separation can be used to upgrade the quality. Once processed, the aggregates can be handled and stored to minimize segregation and degradation and prevent contamination and to also protect from the weather as well as to allow to drain away and/or evaporate moisture. Aggregates, from different sources, or produced by different methods, may differ considerably in particle shape, size and texture. Shape of the aggregates of the present disclosure may be cubical and reasonably regular, essentially rounded, angular, or irregular. Surface texture may range from relatively smooth with small exposed pores to irregular with small to large exposed pores. Particle shape and surface texture of both fine and coarse aggregates may influence proportioning of mixtures in such factors as workability, pumpability, fine-to-coarse aggregate ratio, and water requirement.

As used herein, the term “brine” is used in accordance with its plain ordinary meaning, and refers to a high concentration of salt in water. In embodiments, the concentration ranges from about 3 g of salt per liter of water to 26 g of salt per liter of water. In embodiments, the salt concentration of brine exceeds that of natural seawater. In embodiments, the salt concentration of brine is at least 101% greater than the salt concentration of natural seawater. In embodiments, the salt concentration of brine is ranges from about 101% greater than the salt concentration of natural seawater to about 1000% greater than the salt concentration of natural seawater.

As used herein, the term “cement” is used in accordance with its plain ordinary meaning and refers to powdery substance made for use in making mortar or concrete. For example, cement can be a material that sets, hardens, and/or adheres to other materials to bind them to together, for example to make materials such as concrete. In embodiments, concrete is a mineral binder free of any organic compounds. In embodiments, the present application contemplates a Portland-cement free product. Some embodiments contemplate a reduced Portland Cement containing material with less than 90%, 80%, 70%, 60%, 50%, 40%, 30%, 25%, 20%, 15%, 10%, or 5% of Portland Cement; or any sub value or subrange between 0% and 90%. In embodiments, Portland Cement comprises calcium, silicon, aluminum, and iron. In embodiments, Portland Cement comprises CaO, SiO₂, Al₂O₃, Fe₂O₃, and CaSO₄·H₂O. In embodiments, cement may be characterized as non-hydraulic or hydraulic cement. It should further be understood that “cementious” can mean a material, including a material according the embodiments described herein that has one or more of the characteristics or features of cement.

As used herein, the term “concrete” is used in accordance with its plain ordinary meaning and refers to an artificial, stonelike material used for various structural purposes, made by mixing cement and various aggregates, as sand, pebbles, gravel, or shale, with water and allowing the mixture to harden. In embodiments, the term “stonelike” refers to a material that visually, functionally and/or characteristically resembles stone, including when its hardened state. In embodiments, “concrete-replacement material” is interchangeably used with “artificial, stonelike material” throughout.

As used herein, the term “desalination” is used in accordance with its plain ordinary meaning and refers to the process of removing salts or other minerals and contaminants from seawater, brackish water, and wastewater effluent and it is an increasingly common solution to obtain fresh water for human consumption and for domestic/industrial utilization.

As used herein, the phrase “desalination waste water” refers to reject brine from desalination. In embodiments, the process of removing salt from seawater to afford freshwater produces a highly concentrated brine as a by-product. The by-product is usually disposed of by discharging it back into the sea, a process that requires costly pumping systems and that must be managed carefully to prevent damage to marine ecosystems. This process, if not managed properly, disturbs the local water and sediment by introducing a multi-component waste and increasing temperature, which also endangers the marine organisms due to the residual chemicals mixed into the brine from the pre-treatment process.

As used herein, the term “freshwater” refers to water with a low dissolved salt concentration. In embodiments, freshwater does not include seawater and brackish water. In embodiments, freshwater may include, but is not limited to, frozen and meltwater in ice sheets, ice caps, glaciers, snowfields and icebergs, natural precipitation (e.g., rainfall, snowfall, hail, sleet). In embodiments, the salt concentration is less than 5%, less than 4%, less than 3%, less than 2%, and less than 1%, including sub-values in-between.

As used herein, the term “non-hydraulic cement” is used in accordance with its plain ordinary meaning and refers to cement that does not set in wet conditions or under water. In embodiments, non-hydraulic cement sets as it dries and reacts with CO₂ in the air. In embodiments, non-hydraulic cement is resistant to degradation by chemicals after setting.

As used herein, the term “hydraulic cement” is used in accordance with its plain ordinary meaning and refers to cement that sets in wet conditions due to a chemical reaction between the dry ingredients and water. In embodiments, the chemical reaction results in mineral hydrates that are either completely or nearly insoluble in water. In embodiments, hydraulic cement also refers to Portland Cement.

As used herein, the term “mixing” is used in accordance with its plain ordinary meaning and refers to any form of mixing and may include milling or grinding of substances in solid form.

As used herein, the term “mortar” is used in accordance with its plain ordinary meaning and refers to a material composed of binder(s).

As used herein, the term “negative-carbon dioxide emitting concrete-replacement material” refers to a material that reduces the carbon footprint as opposed to having a lower carbon footprint. In embodiments, the present application contemplates a material that produces carbon credits. In embodiments, the concrete-replacement material absorbs more carbon dioxide than is emitted.

As used herein, the term “seawater” is used in accordance with its plain ordinary meaning and refers to water from the sea or ocean. In embodiments, seawater includes various salts, dissolved inorganic (e.g., minerals) and organic compounds, and other particulates.

As used herein, the term “slag” is used in accordance with its plain ordinary meaning and interchangeably used with “ground-granulated blast-furnace slag.” Ground-granulated blast-furnace slag refers to a composition obtained by quenching molten iron slag (a by-product of iron and steel-making) from a blast furnace in water or steam, to produce a glassy, granular product that is then dried and ground into a fine powder. As contemplated herein, the use of slag reduces iron waste disposal in landfills.

As used herein, the term “slurry” is used in accordance with its plain ordinary meaning and refers to a mixture of denser solids suspended in liquid. In embodiments, the slurry also referred to as brine slurry as contemplated herein is desalinated water waste product.

As used herein, the term “structural component” refers to any vertical or horizontal load-bearing member of a structure which supports dead or live loads in addition to its own weight and includes, but is not limited to, a foundation, an exterior or interior load-bearing wall, a column, a column beam, a floor, and a roof structure.

### II. Compositions

In an aspect, the present embodiments provide a material for use, for example, as a cement and/or concrete material, the material comprising one or more of a brine comprising water, Mg(OH)₂; and slag. The material further can include, for example, an accelerant such as sodium and/or potassium and the like. The material can include the brine in a slurry with the brine and Mg(OH)₂. The material further can include at least one filler. The materials can include at least one aggregate, such as, for example, sand, gravel, crushed stone, and combinations thereof. The material or slurry can include one or more nitrate, sulfate, sodium, chloride, and potassium. In some embodiments the relative ratio of the Mg(OH)₂ to slag can be about 75:25 by wt. % to 25:75 by wt. %, or any subvalue or subrange there between, including but not limited those specifically called out herein. The material can be set upon mixing of the components. The setting can be done by mixing and then pouring the mixture.

The material described herein can be used in any suitable and desired way, including any as described herein. For example, the material can be used or formed into building materials (including as described herein), such as structural foundations and slabs (e.g., by pouring into forms with our without reinforcing material or supports such as for example, rebar, etc.), porches, tiles (e.g., roofing, flooring, wall, etc.), driveways, and sidewalks, blocks, preformed walls or components of walls, rooms, etc., bricks, pavers, articles such as bases of lamps, furniture, frames, and so forth. In short, the materials can be utilized for any end use as described anywhere herein.

In an aspect, the present embodiments provide a material such as a cement and/or concrete-replacement material, for example, set by pouring a concrete mixture, the poured concrete mixture comprising: (a) a brine slurry comprising water and Mg(OH)₂; and (b) slag.

In an aspect, the present embodiments provide an artificial, stonelike material set by pouring a concrete mixture, the poured concrete mixture comprising: (a) a brine slurry comprising water and Mg(OH)₂; and (b) slag.

In embodiments, the brine slurry further comprises one or more nitrate, sulfate, sodium, chloride, and potassium.

In embodiments, sodium and potassium are accelerants.

In embodiments, the poured concrete further comprises at least one aggregate. In embodiments, the at least one aggregate is selected from sand, gravel, crushed stone, and combinations thereof.

In an aspect, the present embodiments provide a concrete-replacement material set by pouring a concrete mixture, the poured concrete mixture comprising: (a) a brine slurry comprising water, Mg(OH)₂, nitrate, sulfate, sodium, chloride, and potassium; (b) slag; and, (c) at least one aggregate.

In an aspect, the present embodiments provide an artificial, stonelike material set by pouring a concrete mixture, the poured concrete mixture comprising: (a) a brine slurry comprising water, Mg(OH)₂, nitrate, sulfate, sodium, chloride, and potassium; (b) slag; and, (c) at least one aggregate.

In embodiments, the concrete-replacement material is set by pouring the concrete mixture and then applying a curing technique to the poured concrete mixture.

In embodiments, the artificial, stonelike material is set by pouring the concrete mixture and then applying a curing technique to the poured concrete mixture.

In embodiments, at least some of the Mg(OH)₂ of the brine slurry is not calcined. In embodiments, the Mg(OH)₂ of the brine slurry is not calcined. In embodiments, the brine slurry is not seawater that has been enriched with Mg²⁺.

In embodiments, the ratio of Mg(OH)₂ to slag is from 75:25 by wt. % to 25:75 by wt. %, or any subvalue or subrange there between, including but not limited those specifically called out herein. In embodiments, the ratio of Mg(OH)₂ to slag is from 70:30 by wt. % to 30:70 by wt. %. In another embodiment, the ratio of Mg(OH)₂ to slag is from 65:35 by wt. % to 35:65 by wt. %. In embodiments, the ratio of Mg(OH)₂ to slag is from 60:40 by wt. % to 40:60 by wt. %. In embodiments, the ratio of Mg(OH)₂ to slag is from 55:45 by wt. % to 45:55 by wt. %. In another embodiment, the ratio of Mg(OH)₂ to slag is about 50:50 by wt. %.

In embodiments, the at least one aggregate is selected from sand, gravel, crushed stone, and combinations thereof.

In some embodiments the concrete mixture does not include, and can specifically exclude, MgO obtained from a calcination reaction. In some embodiments the concrete mixture includes MgO where less than 90%, 80%, 70%, 60%, 50%, 40%, 30%, 25%, 20%, 15%, 10%, or 5% of MgO obtained from a calcination reaction; or any sub value or subrange between 0% and 90%.

In embodiments, the amount of Mg(OH)₂ present in the brine slurry ranges from about 2 wt. % to about 25 wt. %, or any subvalue or subrange there between, including but not limited those specifically called out herein. In embodiments, the amount of Mg(OH)₂ present in the brine slurry ranges from about 5 wt. % to about 20 wt. %. In embodiments, the amount of Mg(OH)₂ present in the brine slurry ranges from about 10 wt. % to about 15 wt. %. In embodiments, the amount of Mg(OH)₂ present in the brine slurry is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. % 17 wt. %, 18 wt. %, 19 wt. %, 20 wt. %, 21 wt. %, 22 wt. %, 23 wt. %, 24 wt. %, 25 wt. %, or subintegers thereof. For example, in embodiments, the amount of Mg(OH)₂ present in the brine slurry is 12.5 wt. %.

In embodiments, the amount of sulfate present in the brine slurry ranges from about 1 wt. % to about 10 wt. %, or any subvalue or subrange there between, including but not limited those specifically called out herein. In embodiments, the amount of sulfate present in the brine slurry ranges from about 2 wt. % to about 8 wt. %. In embodiments, the amount of sulfate present in the brine slurry is about 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of sulfate present in the brine slurry is 4.5 wt. %.

In embodiments, the amount of chloride present in the brine slurry ranges from about 0.1 wt. % to about 5 wt. %, or any subvalue or subrange there between, including but not limited those specifically called out herein. In embodiments, the amount of chloride present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of chloride present in the brine slurry is 4.5 wt. %.

In embodiments, the amount of potassium present in the brine slurry ranges from about 0.1 wt. % to about 5 wt. %, or any subvalue or subrange there between, including but not limited those specifically called out herein. In embodiments, the amount of potassium present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of potassium present in the brine slurry is 4.5 wt. %.

In embodiments, the concrete-replacement material absorbs and retains at least 0.04 kg CO₂ per kg of concrete-replacement material.

In embodiments, the artificial, stonelike material absorbs and retains at least 0.04 kg CO₂ per kg of concrete-replacement material.

In embodiments, the concrete-replacement material absorbs and retains at least 5-16% weight percent of the cement product over a 15-year period.

In embodiments, the artificial, stonelike material absorbs and retains at least 5-16% weight percent of the cement product over a 15-year period.

In another aspect, the present embodiments provide a concrete-replacement material formed from a poured concrete mixture and configured to absorb and retain carbon dioxide, the poured concrete mixture comprising (a) a brine slurry comprising water, Mg(OH)₂, and one or more nitrate, sulfate, sodium, chloride, and potassium; (b) slag; and, (c) optionally at least one aggregate.

In another aspect, the present embodiments provide an artificial, stonelike material formed from a poured concrete mixture and configured to absorb and retain carbon dioxide, the poured concrete mixture comprising (a) a brine slurry comprising water, Mg(OH)₂, and one or more nitrate, sulfate, sodium, chloride, and potassium; (b) slag; and, (c) optionally at least one aggregate.

In embodiments, the Mg(OH)₂ of the brine slurry is not calcined.

In embodiments, the poured concrete mixture absorbs and retains carbon dioxide over a period of time as it is cured and hardened.

In embodiments, the poured concrete mixture absorbs and retains at least 5-16% weight percent of the cement product over a 15-year period.

In embodiments, the at least one aggregate is selected from sand, gravel, crushed stone, and combinations thereof.

In embodiments, the ratio of Mg(OH)₂ to slag is from 75:25 by wt. % to 25:75 by wt. %, or any subvalue or subrange there between, including but not limited those specifically called out herein. In embodiments, the ratio of Mg(OH)₂ to slag is from 70:30 by wt. % to 30:70 by wt. %. In another embodiment, the ratio of Mg(OH)₂ to slag is from 65:35 by wt. % to 35:65 by wt. %. In embodiments, the ratio of Mg(OH)₂ to slag is from 60:40 by wt. % to 40:60 by wt. %. In embodiments, the ratio of Mg(OH)₂ to slag is from 55:45 by wt. % to 45:55 by wt. %. In another embodiment, the ratio of Mg(OH)₂ to slag is about 50:50 by wt. %.

In embodiments, the at least one aggregate is selected from sand, gravel, crushed stone, and combinations thereof.

In some embodiments the concrete mixture does not include, and can specifically exclude, MgO obtained from a calcination reaction. In some embodiments the concrete mixture includes MgO where less than 90%, 80%, 70%, 60%, 50%, 40%, 30%, 25%, 20%, 15%, 10%, or 5% of MgO obtained from a calcination reaction; or any sub value or subrange between 0% and 90%, or any subvalue or subrange there between, including but not limited those specifically called out herein.

In embodiments, the amount of Mg(OH)₂ present in the brine slurry ranges from about 2 wt. % to about 25 wt. %, or any subvalue or subrange there between, including but not limited those specifically called out herein. In embodiments, the amount of Mg(OH)₂ present in the brine slurry ranges from about 5 wt. % to about 20 wt. %. In embodiments, the amount of Mg(OH)₂ present in the brine slurry ranges from about 10 wt. % to about 15 wt. %. In embodiments, the amount of Mg(OH)₂ present in the brine slurry is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. % 17 wt. %, 18 wt. %, 19 wt. %, 20 wt. %, 21 wt. %, 22 wt. %, 23 wt. %, 24 wt. %, 25 wt. %, or subintegers thereof. For example, in embodiments, the amount of Mg(OH)₂ present in the brine slurry is 12.5 wt. %.

In embodiments, the amount of sulfate present in the brine slurry ranges from about 1 wt. % to about 10 wt. %, or any subvalue or subrange there between, including but not limited those specifically called out herein. In embodiments, the amount of sulfate present in the brine slurry ranges from about 2 wt. % to about 8 wt. %. In embodiments, the amount of sulfate present in the brine slurry is about 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of sulfate present in the brine slurry is 4.5 wt. %.

In embodiments, the amount of chloride present in the brine slurry ranges from about 0.1 wt. % to about 5 wt. %, or any subvalue or subrange there between, including but not limited those specifically called out herein. In embodiments, the amount of chloride present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of chloride present in the brine slurry is 4.5 wt. %.

In embodiments, the amount of potassium present in the brine slurry ranges from about 0.1 wt. % to about 5 wt. %, or any subvalue or subrange there between, including but not limited those specifically called out herein. In embodiments, the amount of potassium present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of potassium present in the brine slurry is 4.5 wt. %.

In an aspect, the present embodiments provide a concrete mixture comprising: (a) a brine slurry comprising water and Mg(OH)₂; and (b) slag; wherein the concrete mixture has a pH of at least 8.

In embodiments, the concrete mixture has a pH of at least 8, at least 9, at least 10, at least 11, at least 12, or at least 13. In embodiments the concrete mixture has a pH from 8 to 14, from 8 to 13, 8 to 12, 8 to 11, 8 to 10, or 8 to 9. In embodiments the concrete mixture has a pH from 9 to 14, 9 to 13, 9 to 12, 9 to 11, or 9 to 10. In embodiments the concrete mixture has a pH from 10 to 14, 10 to 13, 10 to 12, or 10 to 11. In embodiments the concrete mixture has a pH from 11 to 14, 11 to 13, or 11 to 12. In embodiments the concrete mixture has a pH from 12 to 14 or 12 to 13. In embodiments, the concrete mixture has a pH from 13 to 14.

In embodiments, the ratio of Mg(OH)₂ to slag is from 75:25 by wt. % to 25:75 by wt. %, or any subvalue or subrange there between, including but not limited those specifically called out herein. In embodiments, the ratio of Mg(OH)₂ to slag is from 70:30 by wt. % to 30:70 by wt. %. In another embodiment, the ratio of Mg(OH)₂ to slag is from 65:35 by wt. % to 35:65 by wt. %. In embodiments, the ratio of Mg(OH)₂ to slag is from 60:40 by wt. % to 40:60 by wt. %. In embodiments, the ratio of Mg(OH)₂ to slag is from 55:45 by wt. % to 45:55 by wt. %. In another embodiment, the ratio of Mg(OH)₂ to slag is about 50:50 by wt. %.

In embodiments, the at least one aggregate is selected from sand, gravel, crushed stone, and combinations thereof.

In some embodiments the concrete mixture does not include, and can specifically exclude, MgO obtained from a calcination reaction. In some embodiments the concrete mixture includes MgO where less than 90%, 80%, 70%, 60%, 50%, 40%, 30%, 25%, 20%, 15%, 10%, or 5% of MgO obtained from a calcination reaction; or any sub value or subrange between 0% and 90%, or any subvalue or subrange there between, including but not limited those specifically called out herein.

In embodiments, the amount of Mg(OH)₂ present in the brine slurry ranges from about 2 wt. % to about 25 wt. %, or any subvalue or subrange there between, including but not limited those specifically called out herein. In embodiments, the amount of Mg(OH)₂ present in the brine slurry ranges from about 5 wt. % to about 20 wt. %. In embodiments, the amount of Mg(OH)₂ present in the brine slurry ranges from about 10 wt. % to about 15 wt. %. In embodiments, the amount of Mg(OH)₂ present in the brine slurry is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. % 17 wt. %, 18 wt. %, 19 wt. %, 20 wt. %, 21 wt. %, 22 wt. %, 23 wt. %, 24 wt. %, 25 wt. %, or subintegers thereof. For example, in embodiments, the amount of Mg(OH)₂ present in the brine slurry is 12.5 wt. %.

In embodiments, the amount of sulfate present in the brine slurry ranges from about 1 wt. % to about 10 wt. %, or any subvalue or subrange there between, including but not limited those specifically called out herein. In embodiments, the amount of sulfate present in the brine slurry ranges from about 2 wt. % to about 8 wt. %. In embodiments, the amount of sulfate present in the brine slurry is about 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of sulfate present in the brine slurry is 4.5 wt. %.

In embodiments, the amount of chloride present in the brine slurry ranges from about 0.1 wt. % to about 5 wt. %, or any subvalue or subrange there between, including but not limited those specifically called out herein. In embodiments, the amount of chloride present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of chloride present in the brine slurry is 4.5 wt. %.

In embodiments, the amount of potassium present in the brine slurry ranges from about 0.1 wt. % to about 5 wt. %, or any subvalue or subrange there between, including but not limited those specifically called out herein. In embodiments, the amount of potassium present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of potassium present in the brine slurry is 4.5 wt. %.

In an aspect, the present embodiments provide a material comprising: (a) salt water material comprising water, Mg(OH)₂, and one or more of nitrate, sulfate, sodium, chloride, and potassium; and, (b) cementious material.

In embodiments, the salt water material comprises brine.

In embodiments, the cementious material comprises slag.

In embodiments, the salt concentration of the salt water material ranges from 101% greater than the salt concentration of seawater to 1000% greater than the salt concentration of seawater, or any subvalue or subrange there between, including but not limited those specifically called out herein. In embodiments, the salt concentration of the salt water material is 101%, 110%, 120%, 130%, 140%, 150%, 160%, 170%, 180%, 190%, 200%, 210%, 220%, 230%, 240%, 250%, 260%, 270%, 280%, 290%, 300%, 310%, 320%, 330%, 340%, 350%, 360%, 370%, 380%, 390%, 400%, 410%, 420%, 430%, 440%, 450%, 460%, 470%, 480%, 490%, 500%, 510%, 520%, 530%, 540%, 550%, 560%, 570%, 580%, 590%, 600%, 610%, 620%, 630%, 640%, 650%, 660%, 670%, 680%, 690%, 700%, 710%, 720%, 730%, 740%, 750%, 760%, 770%, 780%, 790%, 800%, 810%, 820%, 830%, 840%, 850%, 860%, 870%, 880%, 890%, 900% 910%, 920%, 930%, 940%, 950%, 960%, 970%, 980%, 990%, or 1000% greater than the salt concentration of seawater.

In embodiments, the material does not include MgO produced by calcination.

In embodiments, any one of the materials or compositions described herein do not include freshwater. In some embodiments, the materials include no more than 50% fresh water, or any subvalue or subrange from 0% to 50%, for example, including but not limited those specifically called out herein.

In embodiments, the ratio of Mg(OH)₂ to slag is from 75:25 by wt. % to 25:75 by wt. %, or any subvalue or subrange there between, including but not limited those specifically called out herein. In embodiments, the ratio of Mg(OH)₂ to slag is from 70:30 by wt. % to 30:70 by wt. %. In another embodiment, the ratio of Mg(OH)₂ to slag is from 65:35 by wt. % to 35:65 by wt. %. In embodiments, the ratio of Mg(OH)₂ to slag is from 60:40 by wt. % to 40:60 by wt. %. In embodiments, the ratio of Mg(OH)₂ to slag is from 55:45 by wt. % to 45:55 by wt. %. In another embodiment, the ratio of Mg(OH)₂ to slag is about 50:50 by wt. %.

In embodiments, the amount of Mg(OH)₂ present in the brine slurry ranges from about 2 wt. % to about 25 wt. %, or any subvalue or subrange there between, including but not limited those specifically called out herein. In embodiments, the amount of Mg(OH)₂ present in the brine slurry ranges from about 5 wt. % to about 20 wt. %. In embodiments, the amount of Mg(OH)₂ present in the brine slurry ranges from about 10 wt. % to about 15 wt. %. In embodiments, the amount of Mg(OH)₂ present in the brine slurry is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. % 17 wt. %, 18 wt. %, 19 wt. %, 20 wt. %, 21 wt. %, 22 wt. %, 23 wt. %, 24 wt. %, 25 wt. %, or subintegers thereof. For example, in embodiments, the amount of Mg(OH)₂ present in the brine slurry is 12.5 wt. %.

In embodiments, the amount of sulfate present in the brine slurry ranges from about 1 wt. % to about 10 wt. %, or any subvalue or subrange there between, including but not limited those specifically called out herein. In embodiments, the amount of sulfate present in the brine slurry ranges from about 2 wt. % to about 8 wt. %. In embodiments, the amount of sulfate present in the brine slurry is about 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of sulfate present in the brine slurry is 4.5 wt. %.

In embodiments, the amount of chloride present in the brine slurry ranges from about 0.1 wt. % to about 5 wt. %, or any subvalue or subrange there between, including but not limited those specifically called out herein. In embodiments, the amount of chloride present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of chloride present in the brine slurry is 4.5 wt. %.

In embodiments, the amount of potassium present in the brine slurry ranges from about 0.1 wt. % to about 5 wt. %, or any subvalue or subrange there between, including but not limited those specifically called out herein. In embodiments, the amount of potassium present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of potassium present in the brine slurry is 4.5 wt. %.

In embodiments, the process operates, effectively, at ambient pressure and/or gas temperatures. For example, in some embodiments, the curing step is performed at an ambient pressure. In some embodiments, the pressure is about 0.5 to about 10 atm (or any subvalue or subrange there between, including but not limited those specifically called out herein), e.g., about 0.5, 0.6, 0.7, 0.8, 0.9, 1, 1.1, 1.2, 1.3, 1.4, 1.5, 1.6, 1.7, 1.8, 1.9, 2, 3, 4, 5, 6, 7, 8, 9 or 10 atm. In some embodiments, step (3) is performed at an ambient temperature. In some embodiments, the temperature is about 15° C. to about to about 80° C., e.g., about 15° C., 20° C., 25° C., 30° C., 35° C., 40° C., 45° C., 50° C., 55° C., 60° C., 65° C., 70° C., 75° C. or 80° C.

In embodiments, the poured concrete mixture comprises at least one accelerant, wherein the at least one accelerant comprises at least one of the following: magnesium chloride, magnesium nitrate, and magnesium sulfate. In embodiments, the at least one accelerant is present in an amount of about 15 wt. % to about 50 wt. %, or any subvalue or subrange there between, including but not limited those specifically called out herein. In embodiments, the accelerant is present in an amount of about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, or about 50 wt. %. In embodiments, the at least one accelerant is present in an amount of about 15 wt. %-50 wt. %, 15 wt. %-45 wt. %, 15 wt. %-40 wt. %, 15 wt. %-35 wt. %, 20 wt. %-50 wt. %, 20 wt. %-45 wt. %, 20 wt. %-40 wt. %, 20 wt. %-35 wt. %, 25 wt. %-50 wt. %, 25 wt. %-45 wt. %, 25 wt. %-40 wt. %, 25 wt. %-35 wt. %, 25 wt. %-30 wt. %, 30 wt. %-35 wt. %, or values between the foregoing ranges.

In embodiments, the at least one accelerant does not comprise a phosphate-based material. In some embodiments, the at least one accelerant comprises a phosphate-based accelerant, wherein the amount of the phosphate-based accelerant present is about 0.1 wt. % to about 5 wt. % of Mg(OH)₂ of the total mixture, or any subvalue or subrange there between, including but not limited those specifically called out herein. In embodiments, amount of the phosphate-based accelerant present is 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2.0 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3.0 wt. %, 3.1 wt. %, 3.2 wt. %, 3.3 wt. %, 3.4 wt. %, 3.5 wt. %, 3.6 wt. %, 3.7 wt. %, 3.8 wt. %, 3.9 wt. %, 4.0 wt. %, 4.1 wt. %, 4.2 wt. %, 4.3 wt. %, 4.4 wt. %, 4.5 wt. %, 4.6 wt. %, 4.7 wt. %, 4.8 wt. %, 4.9 wt. %, or 5.0 wt. %

In embodiments, a concrete-replacement material resulting from combining the mixture with water is suitable for long-term contact with reinforcing bar, mesh, steel and other materials susceptible to corrosion.

In embodiments, an artificial, stonelike material resulting from combining the mixture with water is suitable for long-term contact with reinforcing bar, mesh, steel and other materials susceptible to corrosion.

In embodiments, an artificial, stonelike material resulting from combining the mixture with water is suitable for long-term contact with reinforcing bar, mesh, steel and other materials susceptible to corrosion.

In embodiments, the mixture further comprises at least one filler material or other additive, the at least one filler or other additive is selected from the following: pumice or other volcanic rock or material, sand, aggregate (e.g., fine aggregate, coarse aggregate, intermediate aggregate, other types of aggregate, etc.), talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

In embodiments for the concrete mixture, the amount of Mg(OH)₂ and slag in the formulation by weight % can be relatively equal to one another. For example, the amount of Mg(OH)₂ to slag can range in a ratio from about 75:25 to about 25:75. In embodiments, the ratio of Mg(OH)₂ to slag is 75:25, 70:30, 65:35, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 35:65, 30:70, or 25:75.

In embodiments, the amount of Mg(OH)₂ present in the brine slurry ranges from about 2 wt. % to about 25 wt. %, or any subvalue or subrange there between, including but not limited those specifically called out herein. In embodiments, the amount of Mg(OH)₂ present in the brine slurry ranges from about 5 wt. % to about 20 wt. %. In embodiments, the amount of Mg(OH)₂ present in the brine slurry ranges from about 10 wt. % to about 15 wt. %. In embodiments, the amount of Mg(OH)₂ present in the brine slurry is about 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. % 17 wt. %, 18 wt. %, 19 wt. %, 20 wt. %, 21 wt. %, 22 wt. %, 23 wt. %, 24 wt. %, 25 wt. %, or subintegers thereof. For example, in embodiments, the amount of Mg(OH)₂ present in the brine slurry is 12.5 wt. %.

In embodiments, the amount of sulfate present in the brine slurry ranges from about 1 wt. % to about 10 wt. %, or any subvalue or subrange there between, including but not limited those specifically called out herein. In embodiments, the amount of sulfate present in the brine slurry ranges from about 2 wt. % to about 8 wt. %. In embodiments, the amount of sulfate present in the brine slurry is about 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of sulfate present in the brine slurry is 4.5 wt. %.

In embodiments, the amount of chloride present in the brine slurry ranges from about 0.1 wt. % to about 5 wt. %, or any subvalue or subrange there between, including but not limited those specifically called out herein. In embodiments, the amount of chloride present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of chloride present in the brine slurry is 4.5 wt. %.

In embodiments, the amount of potassium present in the brine slurry ranges from about 0.1 wt. % to about 5 wt. %, or any subvalue or subrange there between, including but not limited those specifically called out herein. In embodiments, the amount of potassium present in the brine slurry is about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1.0 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 3 wt. %, 4 wt. %, 5 wt. %, 6 wt. %, 7 wt. %, 8 wt. %, 9 wt. %, 10 wt. %, or subintegers thereof. For example, in embodiments, the amount of potassium present in the brine slurry is 4.5 wt. %.

In embodiments, the present application contemplates multiple end uses for the concrete-replacement material. Those uses include, but are not limited to, building construction both residential and commercial (e.g., used in columns, beams and other load-bearing members), walls and other construction panels (e.g., including non-load bearing members), airports, dams, levees, bridges, tunnels, harbors, refineries and other industrial sites, parking structures, roadways, tile and other flooring, sidewalks, pipes, channels, countertops and/or the like. Depending on final cured product's ability to not damage steel or other metals, one or more of formulations or mixes are suitable for use in applications tensile reinforcement is desired or required (e.g., to prevent or reduce the likelihood of cracking, breaking and/or other compromising occurrence to the cured product.) Uses of the present application also contemplate pre-cast materials such as pavers, concrete masonry unit (CMU) blocks and panels for buildings. Other non-structural uses of the present application provided herein may be kitchen islands, decorative garden structures (e.g., birdbaths, benches, planters, pots, etc.), tiles, decorative floors, furniture, bathroom tubs, sinks, tables, hearth, basins, pool deck, or any architectural or decorative application where a concrete-material may be used.

### III. Methods

In an aspect, provided herein is a manufacturing process of a negative-carbon dioxide emitting concrete-replacement material production process and/or product comprising (a) mixing a brine slurry comprising water, Mg(OH)₂, nitrate, sulfate, sodium, chloride, and potassium with slag to form a concrete mixture; (b) pouring the concrete mixture into a structural component mold to form a poured concrete mixture; and then (c) curing the poured concrete mixture from step (b) in the structural mold to form a negative-carbon dioxide emitting concrete-replacement material.

In an aspect, provided herein is a manufacturing process of a negative-carbon dioxide emitting artificial, stonelike material production process and/or product comprising (a) mixing a brine slurry comprising water, Mg(OH)₂, nitrate, sulfate, sodium, chloride, and potassium with slag to form a concrete mixture; (b) pouring the concrete mixture into a structural component mold to form a poured concrete mixture; and then (c) curing the poured concrete mixture from step (b) in the structural mold to form a negative-carbon dioxide emitting artificial, stonelike material.

In another aspect, contemplated herein is a manufacturing process of a negative-carbon dioxide emitting artificial, stonelike material tile. In embodiments, the process may comprise, but is not limited to, (1) extrusion with a clay extruder through a die into the final shape of the roofing tiles; (2) extrusion with a clay extruder through a die into a sheet of thickness equal to or bigger than the final thickness of the tiles and a width that allows for the width of one or multiple tiles. The sheet is formed into the shape of the final tiles either by placing the sheet over a bottom mold half in a vertical press or running the sheet through forming calenders; (3) extruding cylindrical pieces of material that are subsequently formed into the final tile shape between bottom and top molds in a vertical press or similar; or (4) by mixing the rheologically modified material and placing finite metered pieces of the material that are subsequently formed into the final tile shape between bottom and top molds in a vertical press or similar.

In embodiments, any one of the preceding methods may be followed by setting within a couple of hours. In embodiments, roof tiles are dried in an oven.

In embodiments, the mechanical properties are modified to generate a ductile (non-brittle) material by the addition of fiber reinforcement such as cellulose fiber, glass fiber, plastic fiber, polypropylene fiber, polyvinyl alcohol (PVA) fiber, homopolymer acrylic or alkali-resistant fiber, or a combination thereof.

In embodiments, the artificial, stonelike material tiles can be made water resistant by treating the surface of the product to a water repellent silane or water resistant surface coating known in state-of-the-art. Freeze-Thaw resistance can be accomplished by incorporating micro-balloons in the composite composition.

### EXAMPLES

The examples provided herein comprise compositions of cementitious materials comprising Mg(OH)₂ and sourced brine sourced from either seawater or desalinated water waste product. It should be understood to one in skill in the art that the example compositions are non-limiting and may be adjusted based on factors such as heat and humidity to achieve properties such as compressive strength, flexural strength, modulus of elasticity, low deterioration, and absorption of CO₂ contemplated by the present application. The application and examples illustrate that the result-effective variables to achieve these properties include sulfate, nitrate, chloride and Mg(OH)₂.

Materials and Methods. Concentrated brine, in a slurry form, is kept under agitation. To the agitated slurry, ground granulated blast furnace slag (GGBFS) is added. Additional amounts of Mg(OH)₂ is optionally added depending on concentration. Aggregates are mixed into the agitated slurry until the mixture holds shape and has an oatmeal-like consistency. The mixture is poured into molds or forms and allowed to cure.

TABLE 1
Composition A

| | Proportion | Proportion (by weight |
|---|---|---|
| | by weight of | of dry mix) relative to |
| Component | dry mix % | Mg(OH)₂ |
| Mg(OH₎₂ | 20%-25% | |
| slag | 20%-25% | 90%-110% |
| MgCl₂•6H₂O or | 20%-30% | 80%-120% |
| Mg(NO₃)₂•6H₂O | | |
| other accelerators | 0%-2% | 0%-10% |
| aggregates and other | 15%-35% | |
| additives | | |
| Total | 100% | |

Strength Properties of Composition A

| Property | Value |
|---|---|
| 1-day Strength (per ASTM | >1000 psi |
| C39 & ASTM C109) | |
| 7-day Strength (per ASTM | >3000 psi |
| C39 & ASTM C109) | |
| 28-day Strength (per ASTM | >4000 psi |
| C39 & ASTM C109) | |

TABLE 2
Composition B

| | Proportion | Proportion (by weight |
|---|---|---|
| | by weight of | of dry mix) relative to |
| Component | dry mix % | Mg(OH)₂ |
| Mg(OH)₂ | 25%-35% | |
| slag | 25%-35% | 90%-110% |
| MgCl₂•6H₂O or | 0%-3% | 0%-12% |
| Mg(NO₃)₂•6H₂O | | |
| MgSO₄•7H₂O | 3%-18% | 12%-45% |
| other accelerators | 0%-2% | 0%-5% |
| aggregates and other | 10%-45% | |
| additives | | |
| Total | 100% | |

Strength Properties of Composition B

| Property | Value |
|---|---|
| 1-day Strength (per ASTM | >1000 psi |
| C39 & ASTM C109) | |
| 7-day Strength (per ASTM | >3000 psi |
| C39 & ASTM C109) | |
| 28-day Strength (per ASTM | >4000 psi |
| C39 & ASTM C109) | |

TABLE 3
Composition C

| | Proportion | Proportion (by weight |
|---|---|---|
| | by weight of | of dry mix) relative to |
| Component | dry mix % | Mg(OH)₂ |
| Mg(OH)₂ | 2%-15% | — |
| slag | 2%-15% | 75%-125% |
| aggregate (e.g., sand) | 62-92% | |
| additive | 0%-2% | 5%-15% |
| MgSO₄•7H₂O | 1%-6% | 25%-45% |
| Total | 100% | |

Strength Properties of Composition C

| Property | Value |
|---|---|
| 1-day Strength (per ASTM | >1000 psi |
| C39 & ASTM C109) | |
| 7-day Strength (per ASTM | >3000 psi |
| C39 & ASTM C109) | |
| 28-day Strength (per ASTM | >4000 psi |
| C39 & ASTM C109) | |

TABLE 4
Composition D

| Component | Amount by weight % |
|---|---|
| Mg(OH)₂ | 13.2% |
| slag | 13.2% |
| chloride | 1.06% |
| water | 5.67% |
| sulfate (SO₄) | 3.97% |
| potassium | 1.10% |
| aggregates | 61.7% |
| Total | 100% |

Strength Properties of Composition D

| Property | Value |
|---|---|
| 1-day Strength (per ASTM | >1000 psi |
| C39 & ASTM C109) | |
| 7-day Strength (per ASTM | >3000 psi |
| C39 & ASTM C109) | |
| 28-day Strength (per ASTM | >4000 psi |
| C39 & ASTM C109) | |

TABLE 5
Composition E with nitrate

| Component | Amount by weight % |
|---|---|
| (Mg(OH)₂ + Slag | 26.47% |
| chloride | 1.06% |
| sulfate | 3.97% |
| Mg(NO₃)₂ | 1.06% |
| water | 5.67% |
| aggregates | 61.77% |
| Total | 100% |

Strength Properties of Composition E

| Property | Value |
|---|---|
| 1-day Strength (per ASTM | >1000 psi |
| C39 & ASTM C109) | |
| 7-day Strength (per ASTM | >3000 psi |
| C39 & ASTM C109) | |
| 28-day Strength (per ASTM | >4000 psi |
| C39 & ASTM C109) | |

Compressive Strength. The compressive strength of concrete is measured after 3, 7, 14, 28, 56, 90 and 180 days of curing on 50 mm cube specimens in accordance with ASTM C109 using a digital compression machine [ASTM C109-10, Standard Test Method for Compressive Strength of Hydraulic Cement Mortars (Using 2-in. or [50-mm] Cube Specimens), ASTM International, West Conshohocken, Pa., 2010]. The specimens are retrieved from the oven after each curing period and allowed to cool down prior to testing. Triplicate specimens for each curing period are prepared and tested under compression. The average value of three readings is reported.

Flexural Strength. Prismatic specimens measuring 50×50×200 mm are prepared to determine the flexural strength of concrete using third point loading in accordance with ASTM C78 [ASTM C1437-10, Standard Specification for Coal Fly Ash and Raw or Calcined Natural Pozzolan for Use in Concrete, ASTM International, West Conshohocken, Pa., 2010; ASTM C78-10, Standard Test Method for Flexural Strength of Concrete (Using Simple Beam with Third-Point Loading), ASTM International, West Conshohocken, Pa., 2010]. The flexural strength of concrete was determined at 28 and 90 days of curing. Triplicate specimens of each mix for a particular curing period were prepared and tested. The average value of three readings is reported.

Modulus of Elasticity. The modulus of elasticity of concrete is measured on 75 mm diameter and 150 mm high cylindrical concrete specimens. The experiment is conducted in accordance with ASTM C 469 [ASTM C496-10, Standard Test Method for Splitting Tensile Strength of Cylindrical Concrete Specimens, ASTM International, West Conshohocken, Pa., 2010]. The modulus of elasticity is measured after 28 and 90 days of curing.

Lifecycle Carbon Dioxide Emissions

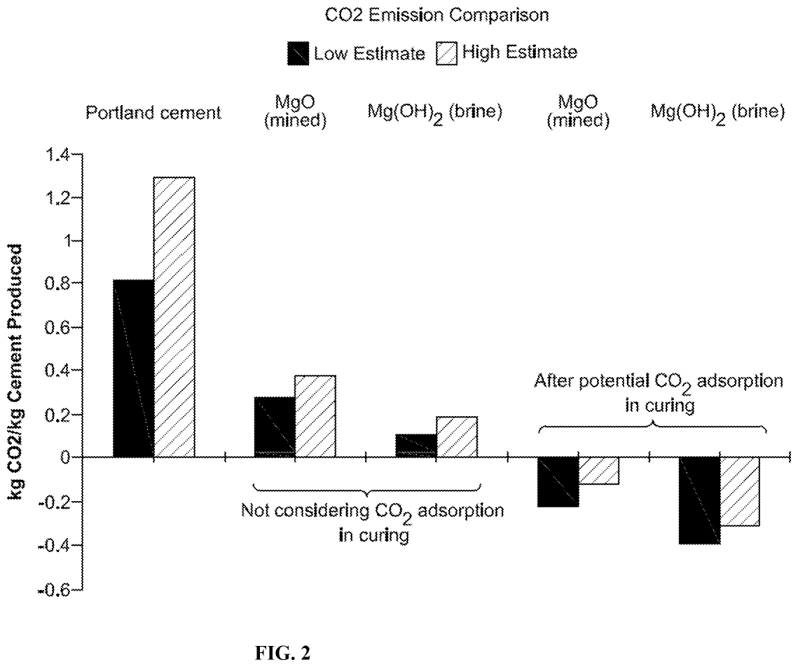

Calculations for the carbon dioxide emissions of FIG. 2 are summarized in Table 2. The raw emission factors they are based on are listed in Table 4.

TABLE 3
Emission Factor Calculations for OPC, MgO (magnesite)
and Mg(OH)₂ brine
Portland Cement-Lifecycle CO₂ Emissions

| | |
|---|---|
| kg clinker/kg cement * | 0.95 |
| Low Estimate, kg CO₂/kg cement: | 0.8075 |
| High Estimate, kg CO₂/kg cement: | 1.2825 |
| Magnesite Lifecycle Calculation-Lifecycle CO₂ Emissions | |

1. Fuel Combustion CO₂ Emissions

| | |
|---|---|
| Energy required to produce 1 ton of MgO, kWh^{†}: | 634.20 |
| Fuel Combustion CO₂ Emissions (Natural Gas Fired), | 0.1265 |
| kg CO₂/kg MgO: | |
| Fuel Combustion CO₂ Emissions (Industrial Coke Fired), | 0.2239 |
| kg CO₂/kg MgO: | |

2. Calcination CO₂ Emissions to produce MgO

| | |
|---|---|
| Calcination CO₂ Emissions, kg CO₂/kg MgO^{†}: | 0.9960 |
| Calcination CO₂ Emissions, kg CO₂/kg MOC | 0.1494 |
| (assuming 15% MgO in dry mix) ^{†}: | |

3. MOC Absorption of CO₂

| | |
|---|---|
| Magnesite MOC Production-Absorption of CO₂, | −0.5000 |
| kg CO₂/kg MOC: | |

Total Lifecycle CO₂ Emissions (Fuel Combustion CO₂ +
Calcination CO₂)

| | |
|---|---|
| Fuel Combustion CO₂ + Calcination CO₂, for | −0.2241 |
| Natural Gas Fired), kg CO₂/kg MOC: | |
| Fuel Combustion CO₂ + Calcination CO₂, for | −0.1267 |
| Industrial Coke Fired), kg CO₂/kg MOC: | |
| Magnesium Hydroxide (Mg(OH)₂)-Lifecycle | |
| CO₂ Emissions | |

1. Combustion CO₂ Emissions

| | |
|---|---|
| Energy required to produce 1 ton of Mg(OH)₂, kWh^{≠}: | 522.50 |
| Fuel Combustion CO₂ Emissions (Natural Gas Fired), | 0.1042 |
| kg CO₂/kg MOC: | |
| Fuel Combustion CO₂ Emissions (Industrial Coke Fired), | 0.1845 |
| kg CO₂/kg MOC: | |

2. Mg(OH)₂ MOC Production-MOC Absorption of CO₂

| | |
|---|---|
| Absorption of CO₂, kg CO₂/kg MOC: | −0.5000 |

Mg(OH)₂ MOC Production-Total Lifecycle CO₂ Emissions

| | |
|---|---|
| Fuel Combustion CO₂-CO₂ Absorbed (for Natural | −0.3958 |
| Gas Fired), kg CO₂/kg MOC: | |
| Fuel Combustion CO₂-CO₂ Absorbed (for Industrial | −0.3155 |
| Coke Fired), kg CO₂/kg MOC: | |

* USGS Background Facts and Issues Concerning Cement and Cement Data estimate non-clinker between 3-7%.
^{†}Kastiukas, G. et al. “Sustainable Calcination of Magnesium Hydroxide for Magnesium Oxychloride Cement Production” Journal of Materials in Civil Engineering 2019, 31(7)
^{≠}Miller, S. and Myers, J., Environmental Impacts of Alternative Cement Binders, Environ. Sci. Technol., 2020, 54, 677-686

TABLE 4
Raw CO₂ Emission & Conversion Factors Used for Calculations
Conversion Factors

| Conversion factor (for MgO Analysis), | 293.1 |
|---|---|
| kWh/MMBtu: | |
| Conversion factor, lb/ton: | 2,000.00 |
| Conversion factor, lb/kg: | 2.204 |
| CO₂ Emission Factors for Portland | |
| Cement Production (including Fuel Combustion) | |
| Low Estimate, kg CO₂/kg clinker | 0.85 |
| High Estimate, kg CO₂/kg clinker | 1.35 |

CO₂ Emission Factors for Fuel Combustion (for MOC Analysis)

| | |
|---|---|
| Natural Gas, kg CO₂/MMBtu | 53.06 |
| Coal (Industrial Coking), kg CO₂/MMBtu | 93.90 |
| Natural Gas, kg CO₂/kWh | 0.1810 |
| Coal (Industrial Coking), kg CO₂/kWh | 0.3204 |

Environmental Impact

The present application contemplates producing a housing structure made with housing material that meets current shortages in housing while generating carbon credits. In embodiments, the housing structure is made with negative-carbon dioxide emitting cementitious material. In further embodiments, the negative-carbon dioxide emitting cementitious material is a cementitious masonry unit manufactured by the processes described herein. The production of the cementitious masonry unit (block) provided herein absorbs carbon dioxide, has reduced output of carbon dioxide based on the methods of making, and does not require fresh water.

Each masonry unit is 0.0076 m 3 volume of cementitious material, which weighs 38.5 lb (17.5 kg). Upon testing, the negative-carbon dioxide emitting cementitious material absorbs 32 kg CO₂/m.t./yr (m.t. refers to metric tons). Therefore, for each block over a 20 year period:

17.5 kg×0.001 m.t./kg×32 kg CO₂/m.t./yr×20 yrs=11.2 kg CO₂/block over 20 years

Each block also produces less carbon dioxide than conventional concrete and other cement products:

0.0076 m³×405 kg CO₂/m³=3.08 kg of CO₂ avoided per block

Therefore, the total carbon credit (avoidance is 11.2 kg CO₂/block+removal is 3.1 kg CO₂/block) is 14.3 kg (31.5 lb) CO₂/block. Note: 405 kg CO₂/m³ is based on DuPont EPD High Test CMU 900003403, issued Aug. 31, 2021 valid through Aug. 31, 2026 (https://www.basalite-cmu.com/_files/ugd/31fd52_c399e811721a4fa4b9fe9cf4bd91c2e6.pdf)

The above calculation is then converted to an application calculation where the cementitious masonry block is combined with mortar (or a filling).

Carbon Removal, 22.6 kg (49.8 lb): 11.2 kg CO₂/Block (Calculation from Above)+11.4 kg (Mortar/Filling)

11.2 kg CO₂/block+[mortar/filling] 11.2 kg CO₂/block×1.02 kg mortar/kg block=22.6 kg CO₂

Carbon Avoidance, 6.22 kg (13.7 lb): 3.08 kg (Calculation from Above)+3.14 kg (Mortar)

3.08 kg (block)+3.08 kg CO₂/block×1.02 kg mortar/kg block=6.22 kg CO₂

Total Carbon Credit (Removal is 22.6 kg CO₂+Avoidance is 6.22 kg CO₂) is 28.8 kg CO₂ (63.5 lb) per block.

The environmental impact of the materials contemplated herein extends to the consumption of fresh water, wherein the compositions of the present application do not utilize fresh water in the manufacturing process. According to the U.S. EPA (https://www.epa.gov/indoor-air-quality-iaq/introduction-indo or-air-quality), carbon dioxide absorption equivalence for a medium-growth coniferous tree allowed to grow for 10 years is 23.2 lb of CO₂ (10.5 kg). Accordingly, referring to the calculations above, each cementitious masonry unit removes 11.2 kg of CO₂, which is approximately equivalent to 1 tree. For each applied cementitious masonry unit, referring to the calculations above, 20.4 kg of CO₂ are removed, which is equivalent to two trees.

In embodiments of the compositions provided herein, the cementitious masonry unit is used for the construction of a house. In embodiments, the size of the house is 1,250 ft². Each house uses 3,000 applied cementitious masonry units. In addition to the mortar and filling material for the applied blocks, each home includes 62.9 m³ of cementitious material in the foundation, slab, porch, roof tiles, driveway, and sidewalks. Using the density of the material, 1,505 kg/m³ (or 94 lb/ft³), 32 kg of CO₂/metric ton/year is absorbed. In embodiments, the present application avoids the need of additional materials such as drywall, insulation, bitumen roofing, and paint.

Carbon Removal for 1 House (1,250 ft²) (116.1 m²)

Applied block: 22.6 kg CO₂×3,000 blocks/house=67,800 kg CO₂ or 67.8 m.t. CO₂ (credits)

Foundation, slab, porch, roof tiles, driveway, and sidewalks: 62.9 m³×1,505 kg/m³×0.001 m.t./kg×32 kg CO₂/m.t./yr×20 yrs=60,585 kg CO₂ or 60.6 m.t. CO₂ (credits)

67.8 m.t. CO₂ (credits)+60.6 m.t. CO₂ (credits)=128.4 m.t. CO₂ (credits)

Carbon Avoidance for 1 House (1,250 ft²) (116.1 m²)

Applied block: 6.24 kg CO₂×3,000 blocks/house=18,720 kg CO₂ or 18.7 m.t. CO₂ (credits)

Foundation, slab, porch, roof tiles, driveway, and sidewalks: 62.9 m³×405 kg CO₂/m³=25,475 kg CO₂ or 25.5 m.t. CO₂ (credits)

18.7 m.t. CO₂ (credits)+25.5 m.t. CO₂ (credits)=44.2 m.t. CO₂ (credits)
Additional Avoidances from Building Processes=10 credits

Total Carbon Credit (Removal+Avoidance) 128.4 m.t. CO₂+44.2 m.t. CO₂+10 m.t. CO₂=182.6 m.t. or credits per house

In embodiments of the compositions provided herein, the negative-carbon dioxide emitting cementitious material is a paver. In embodiments, a plurality of pavers cover a surface area of 100,000 m². In embodiments, the pavers are 3 inches thick (0.2286 m). Accordingly, for a surface area of 100,000 m², the pavers contain a volume of 22,860 m³. Referring to the density of the negative-carbon dioxide emitting cementitious material above, 1,505 kg/m³, 22,860 m³ (volume of paver)×1,505 kg/m 3 (density)×0.001 m.t./kg affords 34,404 metric tons of material used in pavers.

### Carbon Removal for 100,000 m² of Pavers

34,404 m.t.×32 kg CO₂/m.t./yr×20 yrs×0.001 m.t./kg=22,018 m.t. of CO₂ (credits)

### Carbon Avoidance for 100,000 m² of Pavers

22,860 m³×405 kg CO₂/m³=9,258,300 kg or 9,258 m.t. of CO₂ credits

Total Carbon Credit (Avoidance+Removal)=22,018 m.t.+9,258 m.t.=31,276 credits per 100,000 m² of pavers

Although the foregoing embodiments have been described in some detail by way of illustration and Example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. An artificial, stonelike material set by pouring a concrete mixture, the poured concrete mixture comprising:
(a) a brine slurry comprising water and Mg(OH)₂; and,
(b) slag.

2. The artificial, stonelike material of claim 1, wherein the brine slurry further comprises one or more nitrate, sulfate, sodium, chloride, and potassium.

3. The artificial, stonelike material of claim 1, wherein the poured concrete further comprises at least one aggregate comprising sand, gravel, crushed stone, and combinations thereof.

4. (canceled)

5. The artificial, stonelike material of claim 1, wherein the artificial, stonelike material is set by pouring the concrete mixture and then applying a curing technique to the poured concrete mixture.

6. The artificial, stonelike material of claim 1, wherein the Mg(OH)₂ of the brine slurry is not calcined.

7. The artificial, stonelike material of claim 1, wherein the ratio of Mg(OH)₂ to slag is from 75:25 by wt. % to 25:75 by wt. %.

8.-13. (canceled)

14. The artificial, stonelike material of claim 1, wherein the amount of Mg(OH)₂ present in the brine slurry ranges from about 2 wt. % to about 25 wt. %.

15. (canceled)

16. The artificial, stonelike material of claim 1, wherein the amount of sulfate present in the brine slurry ranges from about 1 wt. % to about 10 wt. %.

17. (canceled)

18. The artificial, stonelike material of claim 1, wherein the amount of chloride present in the brine slurry ranges from about 0.1 wt % to about 5 wt. %.

19. (canceled)

20. The artificial, stonelike material of claim 1, wherein the artificial, stonelike material absorbs and retains carbon dioxide of at least 5 weight percent of the artificial, stonelike material over a 15-year period.

21.-39. (canceled)

40. A manufacturing process of a negative-carbon dioxide emitting artificial, stonelike material comprising:
(a) mixing a brine slurry comprising water, Mg(OH)₂, and one or more nitrate, sulfate, sodium, chloride, and potassium, with slag to form a concrete mixture;
(b) pouring the concrete mixture into a structural component mold to form a poured concrete mixture; and then,
(c) curing the poured concrete mixture from step (b) in the structural mold to form a negative-carbon dioxide emitting artificial, stonelike material.

41. The manufacturing process of claim 40, wherein the Mg(OH)₂ of the brine slurry is not calcined.

42. The manufacturing process of claim 40, wherein the ratio of Mg(OH)₂ to slag is from 75:25 by wt. % to 25:75 by wt. %.

43.-47. (canceled)

48. The manufacturing process of claim 40, wherein the amount of Mg(OH)₂ present in the brine slurry ranges from about 2 wt. % to about 25 wt. %.

49. (canceled)

50. The manufacturing process of claim 11, wherein the amount of sulfate present in the brine slurry ranges from about 1 wt. % to about 10 wt. %.

51.-85. (canceled)

86. A method for reducing carbon emissions comprising:
(a) mixing a brine slurry comprising water and Mg(OH)₂, with slag and optionally at least one aggregate to form a cementitious mixture;
(b) pouring the cementitious mixture into a structural component mold to form a poured cementitious mixture;
(c) curing the poured cementitious mixture from step (b) in the structural mold to form a negative-carbon dioxide emitting cementitious material;
thereby forming a negative-carbon dioxide emitting cementitious material that absorbs and prevents the emission of carbon dioxide.

87. The method of claim 86, wherein the reduction of carbon emissions consists of the amount of carbon dioxide absorbed and the amount of prevented carbon dioxide emission.

88. The method of claim 86, wherein the negative-carbon dioxide emitting cementitious material is a cementitious masonry block.

89. The method of claim 88, wherein the cementitious masonry block absorbs 11.2 kg of CO₂ over a 20 year period and removes 3.08 kg of CO₂ per cementitious masonry block.

90.-92. (canceled)

92. The method of claim 86, wherein the negative-carbon dioxide emitting cementitious material is a paver.

93.-94. (canceled)
